(19) United States
(12) Patent Application Publication
(10) Pub. No.: US 2005/0095933 A1
(43) Pub. Date: May 5, 2005

(54) Textile substrates, compositions useful for treating textile substrates, and related methods

(76) Inventors: William C. Kimbrell, Spartanburg, SC (US); Shulong Li, Spartanburg, SC (US); Daike Wang, Duncan, SC (US)

Correspondence Address: John E. Vick;Legal Department, M-495, PO Box 1926, Spartanburg, SC, 29304, US

(21) Appl. No.: 10/699,899

(22) Filed: Nov. 3, 2003

(51) Int. Cl. B32B 33/00

(52) U.S. Cl. 442/93; 428/96; 442/94

(57) ABSTRACT

A textile article such as a floor covering or carpet is disclosed. In one embodiment, a floor covering is provided with a composition applied to the surface of the floor covering. The composition resists staining and dry soiling, and provides liquid repellency and stain release properties. The composition may employ a repellent component, a stain resist component, a stain release, and a particulate component. The composition may be applied to fibrous-containing textiles, such as carpeting. A method of applying the composition to a textile is disclosed. The repellent component may employ a fluorochemical, such as a fluorocarbon. The repellent may be acrylic-based or urethane-based, as two representative examples. The composition is adapted for imparting to a textile a chemical finish that will resist moisture, release stains, and resist dry soiling.

### BACKGROUND OF THE INVENTION

In the manufacture of textiles such as carpets, fabrics and other substrates, it is desirable to improve the properties of the textile substrate to resist soiling or staining during use. For example, water and oil repellency, stain resistance, soil resistance and stain release are highly desirable to facilitate cleaning of such substrates. These properties are distinct, and performance of a textile in all such categories is sometimes difficult to achieve.

Repellency refers to the ability of a textile to repel aqueous or oil based liquids. Thus, a material which has good repellency will not readily absorb liquids, but instead liquids will tend to “roll-up” or be repelled from the surface of such a textile. Achieving relatively high degrees of repellency is generally desirable.

Waxes and wax-like organic compounds have often been used to provide limited degrees of water repellency. For example, textile fabrics first may be scoured with a soap solution, and then subsequently treated with a composition that may include zinc and calcium stearates as well as sodium soaps. Long chain carboxylic acid hydrophobic compounds provide a limited amount of water repellency. It is also possible to render fabrics liquid resistant by treating fabrics with commercially available silicones, for example. It is also very common to provide repellency by applying fluorocarbons to a textile, and many commercially available fluorocarbons are employed in the industry for the purpose of repellency. The so-called post-treatment of textile fabrics such as finished carpets with spray-on materials containing fluorochemicals to impart repellency is practiced in the industry.

“Resistance” or “resist” sometimes refers to the ability of a fiber in a textile to resist undesirable dyeing or color staining. In general, this refers to the ability of a carpet or other surface to resist becoming undesirably dyed or colored due to inadvertent contact with colorants used in various products. For example, food products (such as Kool-Aid®), shoe polishes, mustard, fruit juices, and a host of other products contain dyes that are capable of reacting with, for instance, the free amine groups within the fibers of such textiles, such as textiles made from nylon or wool fibers. Furthermore, dry soiling (and resistance to dry soiling) is very important in the manufacture and subsequent use of such textiles. Dry soil which is not easily removed upon vacuuming provides a visible and noticable color change in a textile. In the case of carpeting, a stained carpet which does not clean well upon vacuuming or steam cleaning would be said to exhibit poor resistance to soiling or staining.

Another property of significance is stain “release”, which indicates the ability of a substrate, once stained by an aqueous or oily liquid or particulate soil, to release such a stain when subsequently cleaned. Typically, this refers to a wet cleaning operation (such as an aqueous carpet cleaning operation), in which the stain, which may be oil-based or hydrophobic, must be solubilized in order to facilitate the removal of the staining material from the surface. Solubilizing an oil-based stain material in an aqueous cleaning solution can present a significant challenge, as the oil-based staining material may be hydrophobic, and therefore may not readily solubilize in a hydrophilic aqueous cleaning solutions. Other cleaning methods employ dry powder cleaners. Such dry powder cleaners function by adsorbing the stain or soil, and the application of such powder is typically followed by vacuuming to remove the stain or soil loaded powder.

In one application of the invention, “substantial” stain release may be defined as the condition in which a majority of the stains are at least about 50% and sometimes as much as about 75%, or greater, removed by a given cleaning procedure.

Several approaches which employ particles or particulate material have been utilized for imparting soil resistance to carpets. One approach involves coating carpet fibers with particulate inorganic oxides, such as silica. The improvement in soil resistance attained by this method or technique is believed to be due in part to the oleophobic surface that the oxide coating presents to potential carpet contaminants.

U.S. Pat. No. 5,908,663 to Wang et al is directed to a method for treating unscoured carpeting. Wang discloses, in examples, employment of a spray or foam application of a (1) fluorochemical repellent, (2) a stain resist component, and (3) colloidal silica. The Wang disclosure specifically teaches the application of such treating compositions for unscoured carpet. Unscoured carpet is carpet which has not been immersed in an aqueous bath of cleaning solution, and which retains in the fibers of the carpet oil residue that adversely affects the ability of a carpet to resist soiling. The treatments recommended by Wang do not provide advantageous results on scoured carpet. Wang indicates that there is virtually no improvement in antisoiling performance that may be achieved in the case of scoured carpet. See Wang, column 18, lines 1-16.

U.S. Pat. No. 5,370,919 to Fieuws et al discloses a treating composition containing a fluoroaliphatic radical containing poly(oxyalkylene) compounds with an anti-soiling agent and organic solvent. However, many problems have been encountered with use of inorganic oxides on carpets. Such materials tend to adhere poorly to the surface carpet fibers, gradually becoming dislodged over time as the carpet wears or is repeatedly vacuumed or cleaned. This results in a loss in soil resistance of the carpet. Furthermore, dislodged particles tend to form a fine dust on the surface of the carpet, thereby detracting from the vibrancy and aesthetic appeal of the carpet. Finally, the organic solvents proposed by Fieuws can lead to difficult environmental issues, such as the release of volatile organic solvents into the atmosphere.

What is needed in the industry is a composition adapted for application to textiles that will impart repellency, stain resistance, and stain release to the textile substrate. A composition which, when applied to a fibrous structure, provides the structure with increased resistance to dry soiling also would be desirable. A textile which has been treated with a composition that affords good repellency to liquids, and also stain release, would be very desirable. Furthermore, a composition that retards color change in the textile (as by soiling) after a routine cleaning operation would be quite useful. A composition which, when applied to textiles, would successfully retard the permanent staining of the textile would be highly desirable.

It is very important that carpet and floor covering exhibit good appearance retention. This can be in terms of a lack of color change, color fastness, a resistance to the crushing of the pile, and inhibition of yellowing of the carpet surface. Color or shade change can be measured, as further provided below.

### SUMMARY OF THE INVENTION

In one embodiment of the invention, a treated textile is provided upon which has been applied a treating composition that is suitable for treating a textile substrate. The composition may comprise, or alternatively may be formed by combining, the following: (a) a repellent component; (b) a stain resist component; (c) a stain release component; and (d) particles. Each of the above components are selected such that application is achieved from a substantially aqueous solution or dispersion. Other components may be added as well, in various formulations of the invention.

Furthermore, in some embodiments of the invention, a single additive may serve as both a stain resist component and a stain release component, such as in the case of commercially available chemical blends, for example. In yet other applications, a stain resist component and/or a stain release component may be employed in or as a blend with a repellent component. Thus, it is possible that the number of chemical products employed in the overall chemical combination may be less than four, for example, while still providing the components as recited in the examples or claims.

In another aspect of the invention, it is possible to provide fibrous substrates which have been treated in accordance with the method/compositions described above which exhibit unexpectedly favorable anti-soiling, anti-staining and repellency performance. The fibrous substrate, having had substantially total penetration of the fluorochemical, (hydrocarbon) stain release compositions, particles and stainblocking materials into and throughout each fiber, exhibits very favorable dynamic water resistance (i.e., resistance to penetration by water-based drinks), and other contaminants, greatly resists staining by aqueous acid staining agents such as red Kool-Aid® drink products, and assists in preventing or retarding oil penetration into the fiber. In the case of carpet, for example, the invention offers significant protection against dry soiling when compared to untreated carpet as demonstrated by “accelerated soiling” tests. The invention provides particularly good results on scoured carpeting.

Various methods and processes also are provided for the practice of the invention.

### BRIEF DESCRIPTION OF THE DRAWINGS

The following Figures illustrate features of at least one embodiment of the invention:

FIG. 1 shows dry soil resistance data obtained in accordance with Examples 27 and 28, as compared to an untreated control, on a “Road Runner” carpet base, as further described below; and

FIG. 2 depicts stain release data for Example 27 and 28, and shows various staining agents, and the stain release obtained for each.

### DETAILED DESCRIPTION OF THE INVENTION

Reference now will be made to the embodiments of the invention, one or more examples of which are set forth below. Each example is provided by way of explanation of the invention, not as a limitation of the invention. In fact, it will be apparent to those skilled in the art that various modifications and variations can be made in this invention without departing from the scope or spirit of the invention.

In the invention, surprisingly beneficial effects may be achieved by employing the disclosed compositions upon substrates, such as fibrous-based textiles, carpets, and the like. Favorable results may be achieved on carpets which have been scoured as well. Scouring is the process of immersing a carpet in a bath of cleaning solution or spraying a cleaning solution onto the textile, followed by removal of the contaminants and solution such as for instance by vacuuming. The cleaning solution reduces the amount of oil residue in the fibers and/or backing of the carpet. Scouring is described in U.S. Pat. No. 3,592,684 (Smith) and U.S. Pat. No. 3,620,823 (Smith).

In some applications of the invention, a scoured carpet or textile material will have applied to its' surface, a fluorochemical repellent component in a concentration of at least about 0.1 percent SOC (“solids on carpet”).

Carpets which have been scoured usually contain fibers having less than about 0.3% by weight oil residue. That is, the oils that naturally are formed in fibers during their manufacture may be removed by scouring, which reduces the oil content in most cases below the stated range of 0.3% or less.

In one embodiment of the invention, unexpectedly it has been discovered that the compositions useful for rendering a substrate with durable stain resistance and stain release may be comprised of a stain release agent, a hydrophobic stain repellency agent, and perhaps also a cross-linking agent. Optionally, other additives may be used to impart various desirable attributes to the textile, floor covering, or carpeted substrate. Within the scope of this invention, new chemical compositions are contemplated wherein the relative amount and chain length of each of the chemical agents may be optimized to achieve the desired level of performance for different target substrates within a single chemical composition.

Many embodiments of the invention are quite economical in the amount of repellent applied to the textile substrate. For example, a repellent application of at least about 0.1% SOC may be applied. This level of repellent is believed to be important in achieving the high levels of stain resistance and release which may be achieved in the practice of the invention.

### Definitions and Terms

“Water repellency” and “oil repellency” are generally defined as the ability of a substrate to block water and oil from penetrating into the substrate, respectively. For example, the substrate may be a textile substrate which is capable of blocking water and oil from penetrating into the fibers of the textile substrate. As yet another example, a carpet may be provided.

“Stain release” generally refers to the degree to which a stained substrate approaches its original, unstained appearance as a result of a care procedure. The term “stain resistant composition or stain resistant treatment” as used herein refers to any treatment or composition that imparts stain resistance to fibers, particularly polyamide or cellulosic fibers. As used herein, stain resistant especially refers to blocking dye sites on a fiber, thereby preventing permanent discoloration of the fiber by a colored staining material.

“Substantial” stain release may be defined as the condition in which a majority of the stains upon a textile are at least about 75% removed by a given cleaning procedure.

“Durability” is generally defined as the ability of a substrate to retain an acceptable level of a desired function through a reasonable number of standard cleaning cycles. More specifically, durability, as described herein, is intended to describe a substrate that maintains adequate properties of stain resistance, water repellency, oil repellency, dry soil resistance, and stain release. This substrate may be a textile substrate, such as, for example, a polyester textile fabric, or alternatively may be a carpet, or yet another textile material. In the case of a carpet, the durability is measured against abrasion, vacuuming or steam cleaning cycles.

The terms “fluorocarbons,” “fluoropolymers,” and “fluorochemicals” may be used interchangeably herein and each represents a polymeric material containing at least one fluorinated segment.

The term “padded” indicates that a liquid coating was applied to a substrate by passing the substrate through a bath and subsequently through squeeze rollers.

“Hydrophilic” is defined as having a strong affinity for or the ability to absorb water.

“Hydrophobic” is defined as lacking affinity for or the ability to absorb water. “High surface energy” is defined as a surface energy equal to or greater than about 25 mJ/m² at about 25° C. as calculated from Fowkes two component approach to solid surface energy.

“Low surface energy” is defined as less than about 25 mJ/m² at about 25° C. as calculated from Fowkes two component approach to solid surface energy.

### Repellency Components

There are numerous compositions that may be adapted to serve as the repellency component in the present invention. One that is particularly useful is a fluorochemical composition. Numerous fluorochemical compositions are knows to be capable of achieving repellency on a fibrous substrate. The 3M Company produces a line of fluorochemical compositions, including Scotchgard™ and the like, that can be employed. Furthermore, DuPont's Zonyl™ product line is also a candidate for the repellency component of the invention. Other products distributed by Daikin Chemical Company of Japan could also be employed. Furthermore, Duratech N-119™ is a fluorinated stain repellant available from DuPont Corporation of Wilmington, Del.

Stain repellency agents which are hydrophobic in nature may include waxes, silicones, certain hydrophobic resins, fluoropolymers, and the like, or combinations thereof. Fluoropolymers may be preferred stain repellency agents. Potentially preferred, non-limiting, compounds of this type include REPEARL® F8025 and REPEARL® F-89, both available from Mitsubishi Corp., as well as ZONYL® 7713 available from DuPont. Treatment of a substrate with a hydrophobic stain repellency agent generally results in a surface that exhibits low surface energy.

Examples of commercially available fluorochemical coatings that may be employed include Scotchgard 358™ and 352™ (3M Corporation) and Zonyl 5180, a fluorochemical dispersion, and Teflon Tuft Coat Anionic™, both manufactured by E.I. Du Pont de Nemours and Company, Inc. Zonyl 5180™ is an aqueous fluorochemical dispersion containing about a 1-10% polyfunctional perfluoroalkyl ester mixture, 10-20% polymethylmethacrylate, and 70-75% water. Teflon Tuftcoat Anionic™ contains 5-10% perfluoroalkyl substituted urethanes, 1-5% polyfunctional perfluoroalkyl esters, and 85-90% water.

Other repellent components that may be employed in the practice of the invention include the following:

Scotchgard Fabric Protector FC-214-30™—a fluorochemical acrylate/urethane commercially available as a 30% (wt) solids aqueous emulsion from 3M, St. Paul, Minn.

Scotchgard Rain and Stain Repeller FC-232™—a fluorochemical acrylate/urethane, commercially available as a 30% (wt) solids aqueous emulsion from 3M.

Scotchgard Carpet Protector FC-358™—a fluorochemical carbodiimide, commercially available as a 20% (wt) solids aqueous emulsion from 3M.

3M Brand Carpet Protector FX-364—a fluorochemical urethane, commercially available as a 23% (wt) solids aqueous emulsion.

3M Brand Protector FX-365™—a fluorochemical urethane commercially availables a 24% (wt) solids aqueous emulsion from 3M.

Scotchgard Carpet Protector FC-1355™—a fluorochemical ester, commercially available as a 45% (wt) solids aqueous emulsion from 3M.

Scotchgard Carpet Protector FC-1367F™—a fluorochemical ester, commercially available as a 41% (wt) solids aqueous emulsion from 3M.

Scotchgard Carpet Protector FC-1373M™—a fluorochemical urethane, commercially available as a 29% (wt) solids aqueous emulsion from 3M.

Scotchgard Carpet Protector FC-1374™—a fluorochemical urethane, commercially available as a 25% (+wt) solids aqueous emulsion from 3M.

Scotchgard. Carpet Protector FC-1395™—a fluorochemical urethane, commercially available as a 25% (wt) solids aqueous emulsion from 3M.

NRD-372™ is a carpet treatment-believed to be a fluorochemical urethane/urea, commercially available as a 27% (wt) solids aqueous emulsion from DuPont.

Zonyl 8779™ is a carpet treatment-commercially available as an 11% (wt) solids aqueous emulsion from DuPont.

Softech 97H™ carpet treatment is believed to be a fluoroalkyl acrylate polymer, commercially available as a 15% (wt) solids aqueous emulsion from Dyetech, Inc., Dalton, Ga.

Shawguard 353™ is a fluoroalkyl acrylate copolymer-commercially available as a 13% (wt) solids aqueous emulsion from Shaw Industries, Inc.

Nuva FT™ is a fluorochemical acrylate polymer-commercially available as a 22% (wt) solids emulsion from Hoechst Celanese, Charlotte, N.C., USA.

Bartex MAC™ is a fluorochemical-commercially available as a 14% (wt) solids emulsion from Trichromatic Carpet, Inc., Quebec, Canada.

Bartex TII™ is a fluoroalkyl acrylate polymer-commercially available as a 16% (wt) solids emulsion from Trichromatic Carpet, Inc.

A fluorochemical coating such as those described above, which may be mixed with other treatment components as provided herein, may be added to the permanently stain resistant fiber to decrease wetting of the fiber and to decrease soiling. The fluorochemical can be applied to the fiber by any means known to those skilled in the art of textile applications, including by spray, exhaust, or foam. Also, more than one fluorochemical repellent may be employed, and the invention clearly is not limited to only the use of those specific products listed above.

### Stain Resist and Stain Release Components

Fibers that can be made permanently stain resistant using the method disclosed herein are those that have functional groups that can displace or react with the X moiety of X-A-Y to form a covalent bond between the fiber and A-Y. Fibers with terminal amino groups, such as polyamides, are suitable because they can displace a number of functional groups, and particularly chlorine groups, from heterocyclic and aromatic compounds under basic conditions. Polyamide fibers with terminal amine groups include nylon, wool, and silk. Polyamides also have terminal carboxyl groups that can be covalently bound through a linking agent to a stain resistant composition.

There are a number of known and commercially available stain resistant compositions for nylon fibers that bind to the fiber through ionic salt linkages, including a broad range of sulfonated aromatic formaldehyde condensation polymers (novolac resins), polymethacrylic acid or copolymers of polymethacrylic acid, and reacted products of the polymerization of alpha-substituted acrylic acids in the presence of novoloid resins. Preferred alpha-substituents include a hydrocarbon, halogenated hydrocarbon, or sulfonated hydrocarbon of from C₁ to C₂₀, phenol, naphthol, sulfonated phenol, sulfonated naphthol or a halogen. Any of these stain resist products can be covalently bound to the fiber through a linking agent.

The monomers useful for copolymerization with the methacrylic acid are monomers having ethylenic unsaturation. Such monomers include, for example, monocarboxylic acids, polycarboxylic acids, and anhydrides; substituted and unsubstituted esters and amides of carboxylic acids and anhydrides; nitriles; vinyl monomers; vinylidene monomers; monoolefinic and polyolefinic monomers; and heterocyclic monomers.

Representative monomers include, for example, acrylic acid, itaconic acid, citraconic acid, aconitic acid, maleic acid, maleic anhydride, fumaric acid, crotonic acid, cinnamic acid, oleic acid, palmitic acid, vinyl sulphonic acid, vinyl phosphoric acid, alkyl or cycloalkyl esters of the foregoing acids, the alkyl or cycloalkyl groups having 1 to 18 carbon atoms such as, for example, ethyl, butyl, 2-ethylhexyl, octadecyl, 2-sulphoethyl, acetoxyethyl, cyanoethyl, hydroxyethyl and hydroxypropyl acrylates and methacrylates, and amides of the foregoing acids, such as, for example, acrylamide, methacrylamide, methylolacrylamide, and 1,1-dimethylsulphoethylacrylamide, acrylonitrile, methacrylonitrile, styrene, .alpha.-methylstyrene, p-hydroxystyrene, chlorostyrene, sulphostyrene, vinyl alcohol, N-vinyl pyrrolidone, vinyl acetate, vinyl chloride, vinyl ethers, vinyl sulphides, vinyl toluene, butadiene, isoprene, chloroprene, ethylene, isobutylene, vinylidene chloride, sulphated castor oil, sulphated sperm oil, sulphated soybean oil, and sulphonated dehydrated castor oil. Particularly useful monomers include, for example, ethyl acrylate, itaconic acid, sodium sulphostyrene, and sulphated castor oil. Mixtures of the monomers can be copolymerized with the methacrylic acid.

The methacrylic polymers that may prove useful in the present invention can be prepared using methods well known in the art for polymerization of ethylenically unsaturated monomers.

Preferably, the methacrylic acid comprises about 30% to 100% by weight, more preferably 60% to 90% by weight, of the methacrylic polymer. The optimum proportion of methacrylic acid in the polymer is dependent on the comonomers used, the molecular weight of the copolymer, and the pH at which the material is applied. When water-insoluble comonomers, such as ethyl acrylate, are copolymerized with the methacrylic acid, they may comprise up to about 40% by weight of the methacrylic polymers. When water-soluble monomers, such as acrylic acid or sulphoethyl acrylate are copolymerized with the methacrylic acid, the water-soluble comonomers preferably comprise no more than 30% by weight of the methacrylic polymer and preferably the methacrylic polymer also comprises up to about 50% by weight water-insoluble monomer.

Generally, the methacrylic polymer should be sufficiently water-soluble that uniform application and penetration of the polymer into the fiber surface can be achieved.

Hydrophilic stain release agents, for example, may include ethoxylated polyesters, sulfonated polyesters, ethoxylated nylons, carboxylated acrylics, cellulose ethers or esters, hydrolyzed polymaleic anhydride polymers, polyvinylalcohol polymers, polyacrylamide polymers, hydrophilic fluorinated stain release polymers, ethoxylated silicone polymers, polyoxyethylene polymers, polyoxyethylene-polyoxypropylene copolymers, and the like, or combinations thereof. Hydrophilic fluorinated stain release polymers may be preferred stain release agents. Compounds of this type include UNIDYNE® TG-992, available from Daikin Corp., REPEARL® SR1100, available from Mitsubishi Corp., as well as ZONYL® 7910, available from DuPont. Treatment of a substrate with a hydrophilic stain release agent generally results in a surface that exhibits a high surface energy under the conditions used for cleaning the substrate and a low surface energy under normal use conditions. One compound that may be employed is Unidyne TG-992®, a hydrophilic, fluorinated stain release component available from Daikin America. It is believed to be a 30% solids fluoroakyl acrylate copolymer.

A stain resist component, which may be employed in the invention, serves to block the dye sites (amine groups) on the fibers of the textile or carpeting by forming weak ionic chemical bonds or covalent bonds. Such components may include, by way of example, partially sulfonated novalak resins; certain acrylic polymers, such as polymethacrylic acid containing polymers; sulfonated polyester polymers; sulfated or sulfonated surfactants and the like.

The compositions of the invention also are particularly useful for employment with all types of flooring and carpeting, including fibrous-based carpeting materials. The invention as disclosed includes substantially permanently stain resistant polyamide and cellulosic fibers, and a method to impart substantially permanent stain resistance to polyamide or cellulosic fibers.

This invention is particularly useful in the preparation of commercial grade carpets for heavy traffic areas that will not lose their stain resistance after frequent vacuuming and/or shampooing. Furthermore, dry soil resistance, that is, the ability of a carpet to resume its original color shade once it is discolored by soil is an important feature of the invention, as further described herein.

The total amount of the chemical composition applied to a substrate, as well as the proportions of each of the chemical agents comprising the chemical composition, may vary over a wide range. The total amount of chemical composition applied to a substrate will depend generally on the composition of the substrate, the level of durability required for a given end-use application, and the cost of the chemical composition.

Accordingly, it may be desirable optionally to treat the textile substrate with finishes containing chemicals such as antimicrobial agents, antibacterial agents, antifungal agents, flame retardants, UV inhibitors, antioxidants, coloring agents, lubricants, antistatic agents, fragrances, and the like, or combinations thereof.

Chemical application may be accomplished by immersion coating, padding, spraying, foam coating, or by any other technique whereby one can apply a controlled amount of a liquid suspension to a textile substrate. Employing one or more of these application techniques may allow the chemical to be applied to the textile substrate in a uniform manner. Many such chemical treatments can be incorporated simultaneously with the chemical composition of the current invention, or such treatments may be carried out prior to treatment with the chemical composition of the current invention. It is also possible, using appropriate techniques, to apply many such chemical treatments after treatment with the chemical composition of the current invention.

Hydrophobic cross-linking agents, which optionally may be included in the invention, include those cross-linking agents which are insoluble in water. More specifically, hydrophobic cross-linking agents may include monomers containing blocked isocyanates (such as blocked diisocyanates), polymers containing blocked isocyanates (such as blocked diisocyanates), epoxy containing compounds, and the like, or combinations thereof. Diisocyanate containing monomers or diisocyanate containing polymers may be the preferred cross-linking agents. However, monomers or polymers containing two or more blocked isocyanate compounds may be the most preferred cross-linking agents. One useful cross-linking agent is REPEARL® MF, also available from Mitsubishi Corp. Others include ARKOPHOB® DAN, available from Clariant, EPI-REZ® 5003 W55, available from Shell, and HYDROPHOBOL® XAN, available from DuPont.

FC-661™ is a stain resist component sold as (3M Brand Stain Release Concentrate). It is also includes compounds capable of providing stain release because it allows acid dye containing stains, such as Red Kool-Aid®, to be removed from a stained textile. It consists of a 29.5% aqueous solution containing a blend of sulfonated novalak and acrylic resins. (see for example, U.S. Pat. No. 5,908,663)

Within the scope of the current invention, it is also contemplated that asymmetric textile substrates may be created with surfaces having dual functional attributes. For example, a textile substrate, having a first and a second surface, may be produced that possesses a first hydrophobic surface and a second hydrophilic surface. Such a dual functional textile substrate may be made, for example, by coating both surfaces of the textile substrate with a hydrophilic stain release agent and then coating the first surface of the substrate with a hydrophobic stain repellent agent and a stain resist component. Chemical application methods include any of those previously discussed, such as spray coating, foam coating, and the like.

### Particulate Components

Various particles or inorganic additives may be used in conjunction with the present invention. Two classes of inorganic additives are inorganic oxides and basic metal salts. Among the inorganic oxides, grafted inorganic oxides (i.e., inorganic oxides grafted with functional groups or polymers) are especially useful in some applications.

In selecting particles that are effective as antisoil additives, various previous considerations remain valid. However, some previously undisclosed criteria have been discovered.

Particles can be inorganic or organic in nature. Typical inorganics include silica, alumina, zirconia, titania, and zinc. These can be in the form of metal oxides or basic metal salts, for example. Such particles can also be surface modified, for instance by grafting.

Without being bound by theory, the particles utilized in the current invention may function by one or more of the following mechanisms. Particles may adsorb oily substances on the surface of the fiber thereby decreasing soil attraction. The particles may provide surface roughness that decreases the overall area, and therefore surface forces, which facilitates soil particles to attach to the fiber. Particles that provide antisoiling properties to surfaces may function by occupying sites on the fiber. This effect has been described as pre-soiling with a colorless “soil”. Particle hardness, surface charge and other parameters most likely also contribute to the observed decrease in soiling that is achieved.

Particle size plays a significant role in the utility of the particle to provide soil resistance and to remain “fixed” to the textile article during use or routine maintenance. Particles that are too small (i.e. <1 nm) may not provide appropriate surface roughness to reduce soil adhesion or may require high loading with subsequent agglomeration to achieve the soil resistant features of the current invention. Particles that are too large (i.e. >0.5 um) may give a frosty, white appearance to dyed textiles or may be removed during use or routine maintenance of the textile. Thus a preferred range of particle size if between about 1 nm and about 0.5 um, or in other instances between about 10 nm and about 0.1 um.

Certain metal ions, such as zirconium, are known to form coordination complexes with a variety of materials. As such, the particle cation can affect other performance attributes of the finished carpet, such as stain release, by binding to the stain release polymer and reducing its effectiveness. This effect has been observed if zirconium acetate is used in the composition of the current invention. In addition, this coordination complex may result in an unstable mix composition that leads to processing problems.

Other inorganic particles may also introduce factors that affect product performance or composition/processing difficulties. For instance, aluminum oxide nanoparticles have been shown to catalyze photo-degradation of disperse dyes on polyester substrates. Certain particles are relatively amorphous (clear and colorless) and therefore do not lead to the white frosty appearance described above. Certain other inorganic particles, including some silicas, can increase composition viscosity resulting in processing difficulties. Therefore, knowledge of particle properties or appropriate technical guidance is essential in particle selection in order to maximize the total appearance retention of textiles, while reducing adverse effects on textile processing.

As used herein, the terms “inorganic oxide” or “metal oxide” are applied to a general class of materials comprising at least one species of metal cation combined with oxygen anions or hydroxyl anions, or mixtures of oxygen and hydroxyl ions. This material can additionally contain water in bound or adsorbed form and can further comprise small amounts, for example less than 5% by weight, stabilized counterions such as sodium ion, carboxylate ion, chloride ion, nitrate ion, or the like. For the purposes of the present invention, it is usually desirable that the metal oxides or inorganic oxides be in a very finely divided state. Colloidal dispersions of the metal oxide provide a particularly useful form for use in the present invention. In general, the activity of the metal oxide in the present invention will increase with finer state of subdivision of the particles.

Additionally, another class of materials—basic metal salts—can impart excellent soil resistance to unscoured carpets when used in a topical manner. Like the metal oxides described above, the basic metal salts also generally comprise a metal cation in chemical combination with oxygen anions or hydroxyl anions or combinations of oxygen anions and hydroxyl anions. However, the basic metal salts further consist of a sufficient amount of acid equivalency to render them soluble in water.

Solutions of these basic metal salts are known to contain poly-nuclear metal cluster cations, that is, cations consisting of more than one metal ion bound together by oxygen and/or hydroxide ligands. Despite the fact that these cluster cations can be quite large, for example, 1-2 nanometers in diameter, when admixed with a suitable carrier fluid or solvent, for example water, these materials fully dissolve to form a true solution. Surprisingly, despite this solubility in the carrier fluid, these basic metal salts can be used in a manner similar to the particulate metal oxides to impart excellent soil resistance to scoured carpet.

Methods for synthesizing these basic metal salts include partial neutralization of a simple metal salt by addition of a base, acid hydrolysis of a metal alkoxide, acid dissolution of a basic metal carbonate, or hydrolysis of a metal salt by ion exchange.

The following inorganic oxides (in addition to those provided in the Examples below) may be utilized in the practice of the present invention:
Nalco 1042™ Colloidal Silica—a 34% solids (by weight) aqueous colloidal acidic silica sol cation available commercially from Nalco Chemical Co. (“Nalco”), Naperville, Ill.
Nalco 1050™ Colloidal Silica—a 50% by weight solids aqueous colloidal silica sol available commercially from Nalco. The sol has a pH of 9, an average particle size of 20 nm in diameter;
Nalco 2326™ Colloidal Silica—a 15% by weight solids aqueous colloidal silica sol available commercially from Nalco. The sol has a pH of 9, an average particle size of 5 nm in diameter;
Nalco 2327™ Colloidal Silica—a 40% by weight solids aqueous colloidal silica sol available commercially from Nalco. The sol has a pH of 9, an average particle size of 20 nm in diameter.
Nalco 2329™ Colloidal Silica—a 40% by weight solids aqueous colloidal silica sol available commercially from Nalco. The sol has a pH of 9, an average particle size of 75 nm in diameter;
Cab-O-Sperse S3295™ Fumed Silica—a 15% by weight solids aqueous dispersion of fumed silica available commercially from Cabot Corporation of Boyertown, Pa. The dispersion has a pH of 9.5, and an average agglomerated primary particle size of about 100 nm in diameter;
Cab-O-Sperse A205™ silica available from Cabot Corporation;
Ludox AS 40™ Colloidal Silica—a 40% by weight solids aqueous colloidal silica sol available commercially from E.I. duPont de Nemours & Co., Wilmington, Del. The sol has a pH of 9, an average particle size of 20 nm in diameter;
Nalco 1056™ Aluminized Silica—a 30% by weight solids aqueous colloidal suspension of aluminized silica particles (26% silica and 4% alumina) available commercially from Nalco;
Nalco. 88SN-126™ Colloidal Titanium Dioxide—a 10% by weight solids aqueous dispersion of titanium dioxide available commercially from Nalco;
Nalco 88SN-123™ Colloidal Tin Oxide—a 22% by weight solids aqueous dispersion of tin oxide available commercially from Nalco;

The following basic metal salts also may be utilized in the present invention: Zirconium Oxyacetate—a zirconium oxydiacetate available from Magnesium Elektron, Inc., Flemington, N.J.

### Bleach Resistance

In one application of the invention, it may be advantageous to apply a bleach resistance in addition to the stain resistance and release properties imparted to a textile fiber. Bleach resistance may be obtained, in part, by applying solutions of monomers and allowing the monomers to react to form a protective film on the fiber. See, for example, U.S. Pat. No. 5,573,553 to McBride et al. The monomers may include oligomers or relatively low molecular weight “polymers” containing functional end groups, which may be reacted to form a non-volatile salt film. The monomers are characterized by compounds which form polymeric, non-volatile salt films, requiring that they are at least bifunctional. Higher functionality monomers, such as a combination of butane tetracarboxylic acid and a diamine also may be used effectively.

### Antimicrobial Component

The terms “antimicrobial component” or “antimicrobial agent” are intended to encompass any compound which exhibits antimicrobial activity. The antimicrobial agent comprises, in one embodiment of the invention, one or more of the following: silver-containing resins, silver-containing zeolites, silver-containing glass, silver-based ion exchange compounds, inorganic antimicrobial materials, metal based zeolites, metal salts, metal oxides, metal hydroxides, transition metal ions, triclosan, pyrithione and derivates, tributyl tin oxide derivates, 3-iodo-2-propylbutyl carbamate, n-butyl-1,2 benziso thiazoline, 10,10′-oxybisphenoxiarsine, sodium o-phenylphenate, and others, to name only some of the possible choices that may be employed.

In many applications, it will be desirable to employ silver-based ion-exchange compounds, a silver-based zeolite, or a silver-based glass, and any combinations thereof. One silver-based ion exchange material is an antimicrobial silver zirconium phosphate (RC-5000®) available from Milliken & Company, under the tradename ALPHASAN.

Generally, such a metal compound may be added in an amount of from about 0.00001 to 10% by total weight of the particular latex composition; or alternatively from about 0.001 to about 5%; or otherwise, from about 0.01 to about 1%; and also from about 0.1 to about 1.0%.

Antimicrobial agents such as Ultrafresh NM™ and Ultrafresh DM-50™, DM-25™ (from Thompson Associates), RC-5000™ (from Milliken Chemical), Chitosante™ (VAG Bioscience, Inc. R.O.C., Taiwan), Kathon LM™ (from Rohm and Haas Company), Zinc Omadine (from Arch Chemical), Reputex 20™ (from Avecia), AM 5700™ (Dow Corning), Amical 48™ (Dow Chemical Co.), also may be employed. In many applications, Zinc Omadine or Sodium Omadine are very effective antimicrobial agents.

Floor Coverings, Carpets, and other Substrates The invention is not limited to any particular base substrate, and may be employed on fabrics, textiles, or carpets. In the case of carpeting, the compositions may be applied to fibers of the tuft or pile. Essentially any type of floor covering having fibrous surfaces may receive the compositions, and benefit from their use. For example, tufted carpets including cut pile, cut and loop, and loop pile may be employed in the practice of the invention. The invention may find application on broadloom carpets, carpet squares, nonwoven carpets, woven carpets, bonded carpets, cushion backed carpets, and even area rugs or mats.

Fibers forming the pile of floor coverings that may benefit from the compositions being applied thereon include, for example: Type 6 nylon fibers; 6,6 nylon fibers, wool fibers, wool/nylon blends, polypropylene, and polyester fibers. The treatment is applicable to both natural and synthetic textile fibers. Thus, by way of example, fibers made from the following materials may be effectively treated according to the methods disclosed herein: polyamides, polyesters including polybutylene terephthalate, polylactic acid fibers, polyolefins, acrylics, and cellulosic fibers such as cotton and rayon. The treatment method is especially useful on polyamide fibers, particularly Nylon 6 and Nylon 6,6.

The term “fiber” is used in a broad sense and is intended to include both staple fibers and filaments. It is not material to the practice of the invention whether the fibers are treated prior to or after being formed into a textile product as long as the fiber has first been dyed. Accordingly, the fiber may be treated in the form of a staple fiber, filament, yarn, woven, knitted, or nonwoven fabric, or adhered to a substrate as by tufting or adhesion. From a manufacturing point of view, since most fibers are dyed after being formed into a textile product, the treatment will usually be applied to a fabric or floor covering product.

Some examples below employ a carpet known by the trade name Sisal Duet™ Model P6396, or “Road Runner”, currently sold by Milliken and Company of Spartanburg, S.C. This base carpet material is a tufted, textured loop pile. It is formed of a face fiber having 100% Milliken Certified WearOn® Type 6,6 Nylon, which is twisted and heatset. It is comprised of a finished face weight of about 20 ounces per square yard, and is 1/10 gauge, provided with rows 10.2/inch, and tufts 102.0/square inches. The finished pile height is 0.17 inches, with a PVC-Free Comfort Plus® cushion backing. The carpet is provided commercially at a nominal total thickness of 0.387 inches, in a tile size of about 36 inches×36 inches.

A second base carpet material that was could be employed in the practice of the invention is commercial sold as Soul® brand carpet, Model P/6301, by Milliken and Company. The base material for this carpet was tested as set forth below, and it comprises a tufted textured loop pile, having a face fiber of 100% DuPont Antron® Legacy Type 6,6 Nylon, which is twisted and heat set for maximum performance. A finished face weight of about 18 ounces per square yard was employed, at a gauge of about 1/13 inches, provided in rows of 12.0 inches and tufts of 156.0 square inches. The finished pile height in the Soul® product is about 0.09 inches, with a nominal total thickness of about 0.26 inches with a usable width of about 69.4 oz./sq. yd.

In accordance with one aspect of the present invention, a cushioned carpet or so-called “cushion backed carpet” having applied to its pile a treating composition which resists staining may be provided. The cushioned carpet comprises a primary carpet having a primary base and a plurality of pile-forming yarns projecting outwardly from one side. A layer of reinforcement material may be bonded to the primary base on the side away from the pile-forming yarns. The reinforcement material may be adjacent to, and embedded at least partially in, a cushion layer of polymer such as polyurethane. There is preferably no additional adhesive between the cushion layer and the layer of reinforcement material. An optional backing material is preferably disposed on the underside of the cushion layer. The backing material may include an adhesive backing on the side away from the cushion layer.

Fabrics useful for receiving compositions of the present invention include many textile materials which include, but are not limited to, woven, non-woven and knitted fabrics, and preferably yarn or piece dyed upholstery woven fabrics, of natural fibers, synthetic fibers and mixtures of natural and synthetic fibers. Suitable natural fibers include, but are not limited to, fibers of cotton, linen, ramie, silk, wool and the like. Suitable synthetic fibers include, but are not limited to, fibers of polyamides (nylon), polyester, polyacrylic, rayon, acetate and the like.

### Soiling Measurements and ΔE Values

The three CIE L*a*b* color coordinates of the soiled carpet samples may be measured using a Minolta 310 Chroma Meter with a D65 illumination source.

The color difference value, ΔE, of each soiled carpet sample is calculated relative to its unsoiled counterpart. This A E measurement in accord with industry procedures, as set forth for example in U.S. Pat. No. 5,908,663 to Wang et al. The ΔE values calculated from these calorimetric measurements have been shown by others to be qualitatively in agreement with values from previously used visual evaluations such as the soiling evaluation suggested by the American Associates of Textile Chemists and Colorists (MTCC). Further, ΔE values have the additional advantages of higher precision, and they are largely unaffected by environment variations or operator subjectivities.

The color shade differential is provided below as ΔE, and the larger the number reported below, the greater is the soiling, and the lesser is the performance. Thus, a low ΔE means that the unsoiled and soiled textile articles are closer in color shade, and therefore is highly desirable. From color theory, ΔE will be different depending on the color or pattern of the carpet and the color or amount of soil used. (Lighter colors will show greater color change after soiling with a dark soil, such as used in the examples.) Therefore the values given in the specification and claims must be adjusted from the values given for white carpet, if another carpet color or pattern is evaluated.

A “ΔΔ” E value also may be calculated, which is a “relative ΔE” value obtained by subtracting from the ΔE value of the soiled treated carpet sample the ΔE value measured for a untreated scoured carpet sample. The lower the ΔΔE value, the better the soil resistance of the treatment. A negative ΔΔE value means that the treated carpet is more resistant to soiling than is untreated carpet.

The L*a*b* color space (also referred to as CIELAB) is presently one of the most popular color space for measuring object color and is widely used in virtually all fields. It is one of the uniform color spaces defined by CIE in 1976 in order to reduce one of the major problems of the original Yxy color space: that equal distances on the x, y chromaticity diagram did not correspond to equal perceived color differences. In this color space, L* indicates lightness and a* and b* are the chromaticity coordinates.

Test methods employed in examples below include the following:

### AATCC Test Method 123-2000 Carpet Soiling: Accelerated Soiling Method

Developed in 1967 by AATCC Committee RA57; editorially revised 1974, 1985, 1990, 1991; reaffirmed 1970, 1973, 1976, 1979, 1982, 1989, 2000; revised 1988; editorially revised and reaffirmed 1995.

1. Purpose and Scope

1.1 This test method describes a procedure for the accelerated soiling of carpets. It can be used to compare the soiling propensity of two or more carpets; or it can be used to soil carpets as a preliminary step in measuring either the ability of a carpet to be cleaned or the efficiency of a cleaning process. This accelerated carpet soiling method has been found to give results similar to floor service soiling, but its use is recommended only as a screening method and not as a replacement for floor testing.

2. Principle

2.1 Specimens of carpet are tumbled together with prepared synthetic soil (see Sections 7 and 8) in a laboratory ball mill for a predetermined time.

3. Terminology

3.1 carpet, n.—all textile floor coverings not designated as rugs.

3.2 soil, n.—dirt, oil, or other substances not normally intended to be present on a substrate such as a textile material.

3.3 soiling, n.—in textiles, a process by which a textile substrate becomes more or less uniformly covered with/or impregnated with soil.

3.4 textile floor covering, n.—an article having a use-surface composed of textile material and generally used for covering floors.

3.5 use-surface, n.—of textile floor covering, the part of a textile floor covering directly exposed to foot traffic.

3.6 accelerated soiling, service soiling, and other key terms will be added when definitions are agreed upon.

4. Safety Precautions

NOTE: These safety precautions are for information purposes only. The precautions are ancillary to the testing procedures and are not intended to be all inclusive. It is the user's responsibility to use safe and proper techniques in handling materials in this test method. Manufacturers MUST be consulted for specific details such as material safety data sheets and other manufacturer's recommendations. All OSHA standards and rules must also be consulted and followed.

4.1 Good laboratory practices should be followed. Wear safety glasses in all laboratory areas.

4.2 Manufacturer's safety recommendations should be followed when operating laboratory testing equipment.

5. Apparatus and Materials

5.1 Jar mill, laboratory, ball, roller type, direct motor driven, 1 L (1 qt) (see 13.1).

5.2 Jar, ball, mill, porcelain, approx. 1 L (1 qt) (see 13.2).

5.3 Flint pebbles, 1.9-2.5 cm (0.8-1.0 in.) diam (see 13.3).

5.4 Soils.

5.4.1 Soil (vacuum cleaner sweepings) (see Section 7).

5.4.2 Synthetic soil (see Section 8). (Synthetic Carpet Soil from Textile Innovators was used . . . lot # 4-16-O₂)

5.5 Vacuum cleaner: tank type; 120 volts; 750 watts; 50-60 cycles; use fabric or upholstery attachment. (A Sears brand Wet/Dry shop vacuum was used)

6. Test Specimens

6.1 Cut two specimens, each 18 cm (7 in.) in warp directions of tufting and 9 cm (3 in.) in filling directions or across tufting direction.

6.2 Condition specimens at room temperature for 16 h prior to use.

7. Soil Preparation

7.1 Take sweepings from a vacuum cleaner. For maximum reproducibility use sweepings from several vacuum cleaners within the surrounding area of the testing facilities.

7.2 Pass sweepings through a 20-mesh screen and then through a 100-mesh screen.

7.3 Take soil which finally passes through the 100-mesh screen and sterilize it (for health reasons) by steaming for 30 min; then air dry.

7.4 Mix soil thoroughly and set aside sufficient quantity to complete the series of tests.

7.5 Do not store soil for more than 4 months.

8. Synthetic Soil Preparation

8.1 Synthetic Soil Formulation:

| Ingredient | % by Weight |
|---|---|
| Peat moss (dark) | 38 |
| Portland cement | 17 |
| Kaolin clay | 17 |
| Silica (200 mesh) | 17 |
| Carbon black (lamp or furnace black) | 1.75 |
| Red iron oxide | 0.50 |
| Mineral oil (medicinal grade) | 8.75 |

8.1.1 Peat moss should be dry and free of lumps.

8.1.2 Portland cement must be dry. If it contains lumps, discard and use fresh supply.

8.1.3 Mix all dry ingredients together thoroughly before adding mineral oil. Dry mix at 50° C. (122° F.) for 6-8 h.

8.1.4 Place dry mixture in ball mill with ceramic balls. Turn mill on and run for approximately 24 h.

8.1.5 Store mixture in vapor tight containers with a dessicant.

9. Soiling Levels

9.1 Soiling levels are predetermined on an arbitrarily selected carpet (control sample) soiled to give light, medium and heavy degrees of soil (see 13.4) preferably by exposure to a service soiling test (see 13.5). (2.0 grams of soil was used for each test)

9.2 Soiling times in the ball mill are determined by soiling unsoiled specimens of the control sample to match the levels of soiling established with soiled control specimens according to 9.1.

9.3 Carpet specimens under evaluation are soiled for given times established in 9.2. (Soiling time was 1 minute for each test)

10. Soiling Procedures

10.1 Place two specimens in the mill jar (see 5.2) with the back of each specimen against the inside cylindrical surface of the jar.

10.2 Place 10 g (2 g) of soil on the face of the carpet specimens as uniformly as possible.

10.3 Add 50 flint pebbles in the porcelain jar and fasten cover to jar.

10.4 Rotate the jar and contents on the ball mill at 250-300 rpm.

10.5 At the end of the predetermined soiling time remove carpet specimens and clean excess soil from carpet specimens by light vacuuming with the tank-type vacuum cleaner. Five strokes with the vacuum cleaner attachment in each direction should be adequate. (We vacuum until no further soil is visibly removed, approximately 30 seconds) Clean all specimens in the same manner.

11. Evaluation of Results (We Evaluate by Instrumental Method, ΔE. Measurements are Made in 3 Locations and the Average ΔE is Reported.)

11.1 It is recommended that AATCC Method 121, Carpet Soiling: Visual Rating Method, be used for evaluation.

11.1.1 It may be necessary to use a visual panel evaluation if time or available equipment does not permit evaluation by AATCC Method 121.

12. Precision and Bias

12.1 Precision. Precision for this test method has not been established. There is no contemplated activity to establish precision for this method. Users of the method should use standard statistical techniques in making any comparison of test results for either within-laboratory or between-laboratory averages.

12.2 Bias. Carpet soiling (accelerated soiling method) can be defined only in terms of a test method. There is no independent method for determining the true value. As a means of estimating this property, the method has no known bias.

13. Notes

13.1 Suitable jar mill is Cat. No. 3440-E05 available from Thomas Scientific, 99 High Hill Rd. at 1-295, P.O. Box 99, Swedesboro N.J. 08085-0099; tel:800/345-2100. Equivalent jar mills are available from other laboratory supply companies.

13.2 Suitable jar is Cat. No. 3440-F15, Size 00, available from Thomas Scientific (see 13.1).

13.3 Suitable flint pebbles are Cat. No. 10484, Large, available from VWR Scientific, P.O. Box 66929, O'Hare, AMF, Chicago, Ill. 60666; tel: 800/932-5000. Equivalent pebbles are available from other laboratory supply companies.

13.4 In the work of Committee RA57, Floor Covering Test Methods, the soiling levels were defined by nylon cut-pile carpet samples soiled to three different levels (light, medium and heavy).

13.5 See AATCC Method 122, Carpet Soiling: Service Soiling Method.

### 3M Oil Repellency Test I

Purpose

This test is designed to detect the presence of fluorochemicals on all types of substrates. It provides a simple, rapid method of measurement, by evaluating the substrate's resistance to wetting by a selected series of hydrocarbon liquids of different surface tensions.

### Limitation

This test is not intended to give an absolute measure of the substrate's resistance to staining by all oily materials. Other factors such as composition and viscosity of the oily substance, substrate construction, fiber type, dyes, other finishing agent, etc., also influence stain resistance. This test can however provide a rough index of oily stain resistance. Generally, the higher the Oil Repellency Rating, the better the resistance to staining by oily materials, especially liquid oily substrates. The test is particularly applicable when comparing various finishes on a given substrate.

### Definition

Oil Repellency is defined as the ability of a substrate to resist wetting by oily liquids.

### Principle

Drops of standard test liquids, consisting of a selected series of hydrocarbons with varying surface tensions, are placed on the substrate surface and observed for wetting. The Oil Repellency Rating is the highest numbered test liquid which does not wet the substrate surface.

### Apparatus and Materials

1. Test liquids prepared and numbered according to Table 1.
   Large Oil Test Kit (Order No. SPS-3010)
      3M Protective Chemical Products Division
      Building 53-1S-02
      St Paul, Minn. 55144-1000
2. Dropper bottles with dropper. (Large Oil Test Kit is supplied with bottles and droppers.)

### Test Samples

One test sample approximately 20×20 cm (8×8 inch) is needed.

### Safety Precautions

Some of the hydrocarbon liquids specified in this test are flammable. Keep away from heat, sparks, and open flame. Use with adequate ventilation. Avoid prolonged breathing of vapor or contact with skin. Do not take internally.

### Test Procedure

1. Place the test sample flat on a smooth, horizontal surface. On pile substrates (i.e., velvets, carpets, etc.) brush pile with back of your hand to direction of greatest pile lay.

2. Beginning with the lowest-numbered test liquid (Oil Repellency Rating No. 1), gently place a small drop approximately 5 mm (3/16 inch) in diameter with the dropper bottle pipette on the test sample in several locations. Do not touch the test sample with the dropper tip. Observe the drop for 30 seconds from approximately a 45° angle.

3. If no penetration or wetting of the substrate at the liquid-substrate interface and no wicking around the drop occurs, place a drop of the next higher numbered test liquid at an adjacent site on the substrate and again observe for 30 seconds.

4. Continue this procedure until one of the test liquids shows obvious wetting of the substrate under or around the drop within 30 seconds.

Note: When evaluating open weave or “thin” fabric, conduct the oil repellency test on at least two layers of the fabric; otherwise the test liquid may wet the underlying surface, not the actual test fabric and cause confusion in the reading of the results.

### Evaluation

The Oil Repellency Rating of a substrate is the highest numbered test liquid which will not wet the substrate within a period of 30 seconds. Wetting of the substrate is normally evidenced by a darkening of the substrate at the liquid-substrate interface. On black or dark shades, wetting can be detected by loss of “sparkle” within the drop.

Different types of wetting may be encountered depending on the finish, fiber, construction, etc., and the determination of the end point can be difficult on certain substrates. Many substrates will show complete resistance to wetting by a given test liquid (as indicated by a clear drop with a high contact angle—see FIG. A) followed by immediate penetration by the next higher numbered test liquid. In these instances the end point, and Oil Repellency Rating, is obvious. However, some substrates will show progressive wetting under several test liquids as evidenced by a partial darkening of the substrate at the liquid/substrate interface (see FIGS. B, C and D). For such substrates, the point of failure is considered to be that test liquid which exhibits complete darkening or apparent wicking of the interface within 30 seconds (FIG. C is the failure point).

Report

The Oil Repellency Rating should be measured on two separate areas of the test sample. If the two ratings are not in agreement, additional determinations should be made and the modal (most frequent) value reported.

TABLE 1
Standard Test Liquids

| | | Surface | |
|---|---|---|---|
| | | Tension | |
| Oil Repellency | | Dynes/cm | Specific Melting Point |
| Rating Number | Composition | at 25° C. | Or Boiling Point Range |
| 1 | Kaydol ® white | 31.5 | |
| | mineral oil | | |
| 2 | 65/35 Kaydol ® | 29.6 | |
| | white mineral | | |
| | oil/n- | | |
| | hexadecane | | |
| | by volume at | | |
| | 21° C. (70° F.) | | |
| 3 | n-hexadecane | 27.3 | 17° to 18° C. |
| 4 | n-tetradecane | 26.4 | 4° to 6° C. |
| 5 | n-dodecane | 24.7 | −10.5° to −9.0° C. |
| 6 | n-decane | 23.5 | 173° to 175° C. |
| 7 | n-octane | 21.4 | 124° to 126° C. |
| 8 | n-heptane | 19.8 | 98° to 99° C. |

Notes:
1. For convenience it is desirable to transfer the test liquids from stock solutions to dropper bottles, each marked with the appropriate Oil Repellency Rating number.
2. Kaydol ® is the product of Witco Chemical Company, for a mineral oil meeting the following specifications: Kinematic viscosity: 64.5-69.7 centistokes at 40° C. (105° F.); Specific gravity: 0.869-0.885 at 25° C. (77° F.). Kaydol ® is available in most drug stores.
3. All other hydrocarbon liquids should be laboratory quality obtainable through most chemical supply houses. One source is Matheson, Coleman and Bell, East

Rutherford, N.J. That company's catalog designations are as listed above.

3M Water Repellency Test II

| | | | Surface Tension |
|---|---|---|---|
| Test Liquid | Percent | Composition of Test Liquid | Dynes/cm at 20° C. |
| W | 100 | Water | 72.8 |
| 1 | 90/10 | Water/Isopropyl Alcohol | 39.0 |
| 2 | 80/20 | Water/Isopropyl Alcohol | 32.0 |
| 3 | 70/30 | Water/Isopropyl Alcohol | 28.3 |
| 4 | 60/40 | Water/Isopropyl Alcohol | 26.6 |
| 5 | 50/50 | Water/Isopropyl Alcohol | 25.0 |
| 6 | 40/60 | Water/Isopropyl Alcohol | 24.3 |
| 7 | 30/70 | Water/Isopropyl Alcohol | 23.7 |
| 8 | 20/80 | Water/Isopropyl Alcohol | 23.3 |
| 9 | 10/90 | Water/Isopropyl Alcohol | 22.4 |
| 10 | 100 | Isopropyl Alcohol | 21.7 |

Test Samples

One test sample approximately 20×20 cm (8×8 inch) is needed.

Test Procedure

1. Place the test sample on a flat, horizontal surface. On pile substrates (i.e., velvets, carpets, etc.) brush pile with back of your hand to direction of greatest pile lay.

2. Using a dropper or pipette, gently place 3 small drops, approximately 5 mm (3/16 inch) in diameter, of the test liquid in two or three different areas on the test sample. Do not touch the test sample with the dropper tip.

3. Allow the drops to stand undisturbed for 10 seconds.

Note: When evaluating open weave or “thin” fabric, conduct the water repellency test on at least two layers of the fabric; otherwise the test liquid may wet the underlying surface, not the actual test fabric and cause confusion in the reading of results.

### Evaluation and Rating

1. If after 10 seconds, two of the three drops are still visible as spherical to hemispherical, the substrate passes the test.

2. Substrates are rated as pass or fail of the appropriate test liquid (W through 10). The numerical rating given a particular substrate is the highest numbered test liquid which remains visible.

The following test method was employed as well.

### AATCC Test Method 171-2000 Carpets: Cleaning of; Hot Water Extraction Method

Developed in 1987 by MTCC Committee RA57; reaffirmed 1988, 1989, 2000; editorially revised 1991, 1997; revised 1995 (with title change), which is hereby incorporated by reference.

Modifications to Test Method:

1. 10 drops of each stain is applied to carpet and rubbed into carpet for 30 seconds with a circular motion of a gloved finger.

2. The stains are allowed to dry overnight (approximately 16 hours).

3. Cleaning solution is 1.0% Tide (powder) in hot tap water (approximately 120 degrees F.).

4. Hot water extraction unit is Bissell Little Green model number 1720-1.

5. Samples are cleaned for a maximum of 2 minutes or until stain is completely removed (less than 2 minutes).

6. Samples are air dried and rated:
4=complete removal
3=good removal (>75%)
2=fair removal (>50%)
1=poor removal (<50%)

### Compositions Employed in Examples

FC-661™, as described below, is a stain resist component sold as (3M Brand Stain Release Concentrate). It is classified as a stain release component as well, because it allows acid dye containing stains, such as Red Kool-Aid®, to be removed. It consists of a 29.5% aqueous solution containing a blend of sulfonated novalak and acrylic resins. (see for example, U.S. Pat. No. 5,908,663)

Duratech N-119™ is a fluorinated stain repellant available from DuPont.

Unidyne TG-992™ is a hydrophilic, fluorinated stain release component having substantial stain release capability, which is available from Daikin America. It is identified as a 30% solids, fluoroakyl acrylate copolymer.

Various examples and embodiments are shown below. Some examples represent certain particular embodiments of the invention, while others represent comparative examples, to compare the performance of textiles treated with compositions of the invention with other samples. In any event, the invention is not limited to solely those specific commercially sold products. Persons of skill in the art, upon reviewing this disclosure, could contemplate other embodiments which follow the teachings herein.

For purposes of the examples below, the following concentration ranges apply:
Stain Repellant Component: about 0.1-10% SOC (solids on weight of face fiber), or in some instances, about 0.25-1.0% OWF;
Stain Resist Component: about 0.25-5.0%; solids on weight of face fiber, or in some instances, about 0.5-1.0% OWF;
Stain Release Component: about 0.1-10%; on weight of face fiber, or in some instances, about 0.1-1.0% OWF; and
Particlate Component: about 0.1%-5.0% on weight of face fiber, or in some instances about 0.1-1.5% OWF.
“OWF” refers to on weight of carpet face fiber.

### EXAMPLE 1

### Repellent Component

“Road Runner” base was sprayed to a wet pick-up of 30% with 5.0% by weight of Duratech N-119™ (a fluorochemical stain and soil repellent sold by DuPont) in water The treated carpet was dried in a Despatch oven for 35 minutes at 270 degrees F.

### EXAMPLE 2

### Repellent Component, Stain Resist Component with Stain Release

“Road Runner” base carpet was sprayed to a wet pick-up of 30% with 5.0% FC-661 (a stain resist and stain release component available from 3M Company) and 0.5% citric acid in water.

The treated carpet is them steamed in a Greenville Steel Steamer at 270 degrees F. for 10 minutes. The carpet was then sprayed with Duratech N-119™ as in Example 1. The carpet was subsequently dried as in Example 1.

### EXAMPLE 3

### Repellent Component, Stain Resist Component, with Stain Release and a Second Stain Release Component Added

Example 2 was repeated, except that 5.0% Unidyne TG-992™ (a fluorochemical stain release agent available from Daikin Chemical) was added to the Duratech bath.

### EXAMPLE 4

### Repellent Component, Stain Resist Component, with Stain Release, and Particulate Component

Example 2 was repeated, except that 5.0% Zirconium acetate solution was added to the Duratech bath.

### EXAMPLE 5

### Repellent Component, Stain Resist Component, with Stain Release, and a Second Stain Release Component Added and Particulate Component

“Road Runner” base was sprayed with about 2.5% FC-661, as in example 2. The carpet was steamed as in example 2. The carpet was then sprayed with 2.5% N-119, 2.5% TG-992 & 5.0% Zirconium acetate solution, as in example 2.

TABLE 1
Data for Examples 1-5

| | Untreated | Example 1 | Example 2 | Example 3 | Example 4 | Example 5 |
|---|---|---|---|---|---|---|
| Dry Soil | 33.7 | 23.7 | 21.4 | 21.4 | 5.8 | 14.8 |
| Resistance | | | | | | |
| (Δ E) | | | | | | |
| Water | 0 | 6 | 4 | 4 | 3 | 3 |
| Repellency | | | | | | |
| (Dupont | | | | | | |
| Method) | | | | | | |
| Oil Repellency | 0 | 4 | 4 | 4 | 4 | 4 |
| Betadine | 1 | 1 | 1 | 1 | 1 | 1 |
| Release | | | | | | |
| Mustard | 1 | 1 | 2 | 2 | 2 | 2 |
| Release | | | | | | |
| Red Kool-Aid | 1 | 1 | 4 | 4 | 2 | 3 |
| Release | | | | | | |
| BMO Release | 1 | 1 | 2 | 3 | 1 | 2 |
| Grape Juice | 2 | 2 | 3 | 4 | 3 | 3 |
| Release | | | | | | |
| Coke Release | 2 | 2 | 4 | 4 | 3 | 3 |

Δ E is total color change after soiling and vacuuming only. Stain Release is 1-4 scale (4 = best)

Δ E is total color change after soiling and vacuuming only. Stain Release is 1-4 scale (4=best)

Table 1 shows the following results:

ΔE is total color change after soiling and vacuuming only. Stain Release is 1-4 scale (4=best).

Table 1 shows that:

fluorochemical (Duratech N-119™) treatment of nylon carpet does not significantly improve stain release by aqueous cleaning, but does improve dry soil resistance.

Addition of hydrophilic stain resist agent (FC-661™) improves stain release by aqueous cleaning, with marginal improvement to dry soil resistance.

Addition of fluorinated hydrophilic stain release polymer (Unidyne TG-992) gives further improvement to stain release, but not to dry soil resistance.

Addition of Zirconium acetate solution to Duratech N-119™ and FC-661™ has an adverse effect on stain removal, but greatly enhances dry soil resistance.

Addition of Zirconium acetate to Duratech N-119™, FC-661™ and Unidyne TG-992™ improves dry soil resistance with a marginal decrease in stain removal.

### EXAMPLE 6

### Untreated

Untreated, undyed “Soul” base carpet.

### EXAMPLE 7

### Repellent Component Only

Repeat of Example 1 on “Soul” base.

### EXAMPLE 8

### Repellent Component, Stain Resist Component, with Stain Release

Repeat of Example 2 on “Soul” base.

### EXAMPLE 9

### Repellent Component, Stain Resist Component with Stain Release

Example 8 was repeated, except 5.0% TG-992™ was added to Duratech bath:

### EXAMPLE 10

### Repellent Component, Stain Resist Component, Stain Release, and Particulate Component

Repeat of Example 5 on “Soul” Base, except Duratech and TG-992™ were increased to 5.0% each and Alumina (W440 VPW630 available from Degussa Corporation) was substituted for Zirconium.

Results for examples 6-10 are given in Table 2, below.

TABLE 2
Data for Examples 6-10

| | Example 6 | Example 7 | Example 8 | Example 9 | Example 10 |
|---|---|---|---|---|---|
| Dry Soil Resistance (Δ E) | 24.8 | 14.8 | 11.1 | 36.0 | 9.2 |
| Water Repellency | 0 | 7 | 4 | 7 | 6 |
| Oil Repellency | 0 | 6 | 5 | 5 | 5 |
| Betadine | 1 | 1 | 1 | 2 | 1 |
| Mustard | 1 | 1 | 2 | 1 | 2 |
| Red Kool-Aid | 1 | 1 | 4 | 1 | 4 |
| BMO | 1 | 1 | 1 | 1 | 3 |
| Grape Juice | 2 | 3 | 4 | 2 | 4 |
| Coke | 3 | 4 | 4 | 4 | 3 |

Stain release numbers for example 7 are for 10% Duratech.

Table 2 above shows similar results as shown in Table 1, but on a different carpet substrate. This data indicates that the invention may apply to a variety of substrates.

### EXAMPLE 11

### Untreated

Untreated “Roadrunner” base.

### EXAMPLE 12

### Repellent Component

Repeat of Example 1.

### EXAMPLE 13

### Repellent Component, Stain Resist, Stain Release, and Particulate Component

Repeat of Example 4.

### EXAMPLE 14

### Repellent Component, Stain Resist, Stain Release, and Particulate Component

Repeat of Example 3, except 5.0% Zirconium Acetate solution was added to N-119™ & TG-992™.

Results for Examples 11-14 are shown in Table 3 below.

TABLE 3
Dry Soil Resistance and Removal (Delta E)

| | | Example | Example | Example |
|---|---|---|---|---|
| | Example 11 | 12 | 13 | 14 |
| Soil/Vacuum | 31.6 | 21.2 | 11.5 | 16.7 |
| Soil/Vacuum/Extract | 10.7 | 13.2 | 11.2 | 6.6 |
| Soil/Vacuum/Extract | 8.5 | 9.1 | 4.9 | 3.7 |
| 2X | | | | |
| Soil/Vacuum/Extract | 6.7 | 7.8 | 4.9 | 3.4 |
| 3X | | | | |

Dry soil is more difficult to clean by aqueous methods from fluorochemical (Duratech N-119™) treated carpet than from untreated nylon carpet.

Nylon carpet treated with stain release compositions, fluorochemicals, stain resist compositions and particles release dry soil better than untreated nylon carpet.

The best soil removal is obtained when fluorinated stain release compositions are used.

### Control

### EXAMPLE 15

Undyed, untreated Roadrunner base.

### EXAMPLE 16

### Repellent Component, Stain Resist, Stain Release, and Particulate Component

Example 4 was repeated, except an aluminum oxide particle (W440 VPW630™ available from Degussa Corporation) was substituted for the Zirconium acetate.

### EXAMPLE 17

### Repellent Component, Stain Resist, Stain Release, and Particulate Component

Example 4 was repeated, except a zinc oxide particle (DP5370™ available from Nalco) was substituted for the Zirconium acetate.

### EXAMPLE 18

### Repellent Component, Stain Resist, Stain Release, and Particulate Component

Example 4 was repeated, except a zirconium oxide particle (Zr 50/20 available from Nalco) was substituted for the Zirconium acetate.

### EXAMPLE 19

### Repellent Component, Stain Resist, Stain Release, and Particulate Component

Example 4 was repeated, except a silica particle (DP5540™ available from Nalco) was substituted for the zirconium acetate solution.

### EXAMPLE 20

### Repellent Component, Stain Resist, Stain Release, and Particulate Component

Example 19 was repeated, except a different silica particle (DP5480™ available from Nalco) was used.

Results from Examples 15-20 are shown in Table 4, below.

TABLE 4
Data for Examples 15-20

| | Example | Example | Example | Example | Example | Example |
|---|---|---|---|---|---|---|
| | 15 | 16 | 17 | 18 | 19 | 20 |
| Dry Soil | 13.4 | 6.6 | 13.1 | 18.2 | 16.5 | 17.1 |
| Resistance (Δ E) | | | | | | |
| Water Repellency | 4 | 4 | 4 | 3 | 4 | 4 |
| Oil Repellency | 5 | 4 | 5 | 4 | 5 | 5 |
| Betadine Release | 1 | 1 | 1 | 1 | 1 | 1 |
| Mustard Release | 2 | 1 | 2 | 2 | 2 | 2 |
| Red Kool-Aid | 3 | 4 | 4 | 3 | 4 | 4 |
| Release | | | | | | |
| BMO Release | 2 | 3 | 2 | 3 | 2 | 2 |
| Grape Juice | 4 | 3 | 3 | 4 | 4 | 4 |
| Release | | | | | | |
| Coke Release | 4 | 4 | 3 | 3 | 4 | 3 |

The results from Table 4 indicate minor differences in performance depending on the particle selected, but all of the tested particles provide improved performance. Therefore, selection of one type particle may provide optimum dry soil resistance, while another particle may provide optimum stain release performance. It is conceivable that some particles may provide optimum performance for all properties tested, or that a blend of particles may be beneficial.

### EXAMPLE 21

### Repellent Component, Stain Resist, Stain Release, and Particulate Component

Example 4 was repeated, except that the Zirconium acetate was replaced with silica (Nalco DP5540™).

### EXAMPLE 22

### Repellent Component, Stain Resist, Stain Release Component, and Particulate Component

Example 21 was repeated, except all chemicals were reduced by 50%.

### EXAMPLE 23

### Repellent Component, Stain Resist, Stain Release, and Particulate Component

Example 21 was repeated, except that all chemicals were reduced by a further 50%.

### EXAMPLE 24

### Repellent Component, Stain Resist, Stain Release, and Particulate Component

Example 23 was repeated, except the silica was increased to the original 5% concentration.

Results for Examples 21-24 are given in Table 5 below.

TABLE 5
Data for Examples 21-24

| | | Example | Example | Example |
|---|---|---|---|---|
| | Example 21 | 22 | 23 | 24 |
| Dry Soil Resistance | 15.5 | 16.0 | 17.5 | 19.4 |
| (Delta E) | | | | |
| Water Repellency | 4 | 4 | 4 | 4 |
| Oil Repellency | 4 | 4 | 4 | 4 |
| Betadine Release | 1 | 1 | 1 | 1 |
| Mustard Release | 3 | 3 | 2 | 2 |
| Red Kool-Aid Release | 4 | 4 | 4 | 4 |
| BMO Release | 2 | 2 | 2 | 2 |
| Grape Juice Release | 4 | 4 | 4 | 4 |
| Coke Release | 4 | 4 | 4 | 4 |

Table 5 shows a trend of reduced performance as the level of treatment is reduced. However, significant improved performance is still obtained at the lowest level evaluated.

### EXAMPLE 25

### Repellent Component, Stain Resist, Stain Release, and Particulate Component

A sample of “Roadrunner” carpet base was sprayed with a 5% solution of alumina particles (W440 VPW630™ available from Degussa Corporation) to a wet pick-up of 30% and dried. 5.0% FC-661 & 0.5% citric acid was sprayed to a pick-up of 30% and steamed. 5% N-119 was then sprayed to a pick-up of 30% and the carpet was dried.

### EXAMPLE 26

### Repellent Component, Stain Resist, Stain Release, and Particulate Component

Example 25 was repeated, except that The FC-661/citric acid was applied first, followed by spraying N-119™ and VP together and drying.

Results were similar for both sequences of treatments.

### EXAMPLE 27

### Prior Art

A mix was prepared containing 4.6% Millitex MC-101C (a bleach resistant chemical described commercially distributed by Milliken & Company) and 2.3% Milliguard FS2 (an acrylic stain resistant polymer available from Milliken Chemical). This mix was sprayed onto undyed “Roadrunner” carpet base and steamed as in Example 1.

A mix containing 0.5% Duratech N-119™ was sprayed onto the above treated sample and dried as in Example 1.

This formulation represents a commercial carpet treatment currently in use in the market.

### One Embodiment of Invention

### EXAMPLE 28

Example 27 was repeated, except the second mix contained 2.6% Duratech N-119™, 2.6% FC-661™ and 3.9% Cab-O-Sperse A205™.

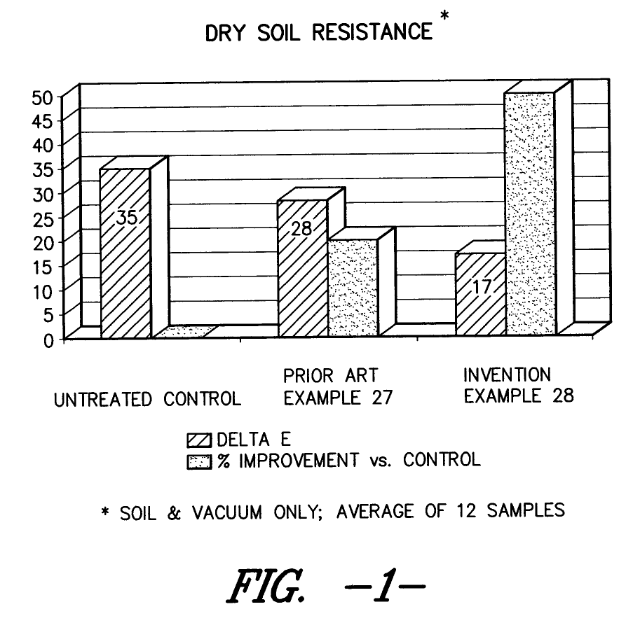

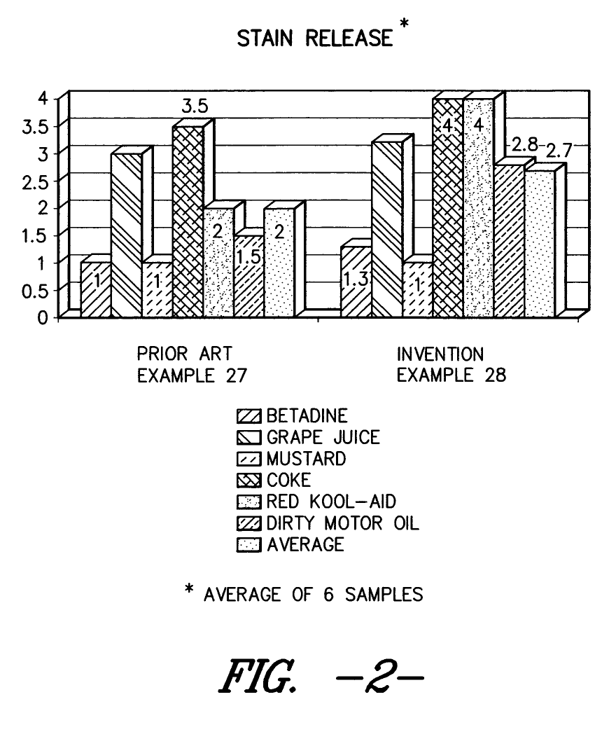

This formulation of this example is one example of the current invention. FIGS. 1 and 2 are graphical representations of the enhanced appearance upon carpet that may be obtained by the current invention. FIGS. 1 and 2 show the improved dry soil resistance and stain release obtained utilizing the composition of the current invention, when compared to a typical commercial carpet treatment, as in Example 27.

### EXAMPLE 29

Examples 1, 4, 5 and untreated control, all on undyed “Roadrunner” base carpet were reproduced on carpet that was scoured prior to treatment. Dry Soil resistance between unscoured and scoured carpet is shown in Table 6 below:

TABLE 6
Dry Soil Resistance (Delta E): Scoured Carpet

| | Unscoured | Scoured |
|---|---|---|
| Untreated Control | 33.7 | 31.6 |
| Example 1 | 23.7 | 21.2 |
| Example 4 | 5.8 | 11.5 |
| Example 5 | 14.8 | 16.7 |

The results from Table 6 indicate that the composition of the current invention provides unexpected and substantial improvements on scoured carpet.

### EXAMPLES 30-36

Two different wool carpets were purchased from Carpet One, a distributor of carpeting. The first was a tan color in a construction similar to Roadrunner. The second was an off-white coarse berber-type construction. In addition, a polyester velour automotive upholstery fabric dyed in a tan color (Style 3868 available from Milliken & Co.) was obtained.

These substrates were tested as received and after application of the composition given in Example 28. Test results for these substrates are given in Table 7.

TABLE 7
Wool and Polyester Substrate Test Results

| | Untreated | Treated | Untreated | Treated | Untreated | Treated |
|---|---|---|---|---|---|---|
| | Wool #1 | Wool #1 | Wool #2 | Wool #2 | Polyester | Polyester |
| Dry Soil | 24.3 | 8.9 | 12.7 | 7.6 | 25.1 | 13.4 |
| Resistance ΔE | | | | | | |
| Water | N/E | N/E | N/E | N/E | N/E | N/E |
| Repellency | | | | | | |
| Oil | N/E | N/E | N/E | N/E | N/E | N/E |
| repellency | | | | | | |
| Betadine | 4 | 4 | 4 | 4 | 3.7 | 3.3 |
| Release | | | | | | |
| Mustard | 3 | 3 | 3 | 3 | 4 | 3 |
| Release | | | | | | |
| Red Kool- | 2 | 3 | 1.7 | 3 | 4 | 4 |
| Aid Release | | | | | | |
| BMO | 1 | 2 | 3 | 1.7 | 3 | 2.3 |
| Release | | | | | | |
| Grape Juice | 4 | 4 | 4 | 4 | 4 | 4 |
| Release | | | | | | |
| Coke | 4 | 4 | 4 | 4 | 4 | 4 |
| Release | | | | | | |

The results in Table 7, show the effectiveness of the composition of the current invention on a variety of fiber types and constructions.

### EXAMPLE 37

Samples of undyed Roadrunner base were treated with the composition of example # 27 and tested after multiple vacuumings or hot water extractions to examine the durability of the composition.

### EXAMPLE 38

Samples of undyed Roadrunner base were treated with the composition of example #28 and tested as in example 37.

Dry soil resistance durability against vacuuming results for Examples 37 & 38 are given in Table 8. Each result is the average of 5 test specimens. Results are given for sequential soil/vacuum cycles, and is therefore a cumulative result. Stain Removal durability results against hot water extraction for examples 37 & 38 are provided in Table 9.

TABLE 8
Dry Soil Resistance Durability Against Vacuuming

| | Example 37 | Example 38 |
|---|---|---|
| 1^{st} cycle Δ E | 30 | 17 |
| 2^{nd} cycle Δ E | 35 | 25 |
| 3rd cycle Δ E | 38 | 31 |

The results in table 8 indicate that the composition of the current invention provides an improvement against dry soiling even after multiple soil/vacuum cycles.

TABLE 9
Stain Release Durability Results Against Hot Water Extraction

| | Example 37 | Example 38 |
|---|---|---|
| Grape Juice Release (extracted | 3 | 4 |
| 0X before staining) | | |
| Grape Juice Release (extracted | 3 | 4 |
| 1X before staining) | | |
| Grape Juice Release (extracted | 3 | 4 |
| 2X before staining) | | |
| Coke Release (extracted 0X | 3.7 | 4 |
| before staining) | | |
| Coke Release (extracted 1X | 3.3 | 4 |
| before staining) | | |
| Coke Release (extracted 2X | 3.7 | 4 |
| before staining) | | |
| Red Kool-Aid Release (extracted | 2.3 | 4 |
| 0X before staining) | | |
| Red Kool-Aid Release (extracted | 2 | 3.3 |
| 1X before staining) | | |
| Red Kool-Aid Release (extracted | 1.7 | 3 |
| 2X before staining) | | |
| BMO Release (extracted 0X | 2 | 2.3 |
| before staining) | | |
| BMO Release (extracted 1X | 1.3 | 2.7 |
| before staining) | | |
| BMO Release (extracted 2X | 1.3 | 2.3 |
| before staining) | | |

The results in Table 9 indicates that the stain release performance of the composition of the current invention is retained after multiple hot water extraction cycles.

The above examples and demonstrations reveal that it is possible in the practice of the invention to provide a treated textile substrate that provides a relative resistance to dry soiling having a color shade change ΔΔE in absolute value upon soiling and vacuuming of about 10 or less. In other applications, the ΔΔE value may be no more than about 20, or in other applications no more than about 30, and in yet other applications no more than about 50. By “absolute value” it is meant that the ΔΔE is typically a negative number, but absolute value means the absolute difference between the invention or example as practiced and an untreated control which does not contain the features of the invention; wherein the absolute value is expressed as a positive number.

It is understood by one of ordinary skill in the art that the present discussion is a description of exemplary embodiments only, and is not intended as limiting the broader aspects of the present invention, which broader aspects are embodied in the exemplary constructions. The invention is shown by example in the appended claims.

1. A floor covering substrate, said floor covering substrate having applied thereon a treating composition, said composition comprising:
(a) a fluorochemical-containing repellent component;
(b) a stain resist component; and
(c) a particulate component;
wherein said treating composition is adapted to provide to said floor covering substrate substantial stain release and substantial resistance to dry soiling.

2. The substrate of claim 1 wherein said stain resist component comprises at least one component selected from the group consisting of: sulfonated novolak resins, acrylic polymers, sulfonated polyester polymers, and sulfonated surfactants.

3. The substrate of claim 1 wherein said fluorochemical comprises an acrylic polymer.

4. The substrate of claim 1 wherein said stain resist component is selected from the group consisting of: fluorochemical agents, acid-containing acrylic polymers, copolymers, ethoxylated polyesters, nylon, cellulose derivatives, polyacrylamides, sulfonated polymers, and sulfonated polyesters.

5. The substrate of claim 1 wherein said substrate is scoured.

6. The substrate of claim 1 wherein said particulate component comprises at least one component selected from the group consisting of: silica-containing materials, zirconium-containing materials, titanium-containing materials, alumina-containing materials, basic metal salt materials, and metal oxide materials.

7. A floor covering having an applied composition for imparting soil resistance, stain resistance, and stain release, said floor covering comprising:
(a) a scoured substrate having fibers forming a pile;
(b) a composition applied to said scoured substrate, said composition comprising:
(i) a first fluorochemical repellent component, said fluorochemical repellent component being provided at a concentration of at least about 0.1% SOC;
(ii) a second stain blocking component, said stain blocking component being selected from one or more of the group consisting of: sulfonated novolak resins, acrylic polymers, sulfonated polyester polymers, sulfonated surfactants, fluorochemical agents, acid-containing acrylic or acrylate polymers and copolymers, ethoxylated polyesters, ethoxylated nylon, cellulose derivatives, polyacrylamides, sulfonated polymers, and sulfonated polyesters; and
(iii) an inorganic particulate component, said inorganic particulate component being selected from the group consisting of: silica-containing materials, zirconium-containing materials, titanium-containing materials, alumina-containing materials, inorganic oxide materials, basic metal salt materials, and metal oxide materials; and
(c) wherein said composition is adapted for imparting substantial stain resistance and stain release to said floor covering.

8. The floor covering of claim 7 further wherein said composition further comprises a crosslinking compound.

9. The floor covering of claim 7 wherein said composition further comprises at least two distinct component types which afford stain release properties to said floor covering.

10. The floor covering of claim 7 wherein said fibers of said scoured substrate comprise less than about 0.3% by weight oil residue.

11. A treated scoured floor covering having applied thereon a composition for imparting soil resistance and stain release to said treated floor covering, said floor covering comprising:
(a) a scoured substrate having a plurality of fibers, said fibers having less than about 0.3% by weight oil residue;
(b) a composition comprising:
(i) a fluorochemical repellent component;
(ii) a stain resist component;
(iii) at least one component which imparts substantial stain release to said substrate; and
(iv) an inorganic particulate component.

12. The treated scoured floor covering of claim 11 in which said composition of said treated scoured carpet further comprises a bleach resistant component.

13. The treated scoured floor covering of claim 11 wherein said fluorochemical repellent component is provided at a concentration of at least about 0.1% SOC.

14. The treated floor covering of claim 11 wherein said stain resist component comprises at least one component selected from the group consisting of: sulfonated novalak resins, acrylic polymers, sulfonated polyester polymers, and sulfonated surfactants and combinations thereof.

15. The floor covering of claim 11 wherein said repellent component comprises a hydrophilic fluoroalkyl acrylate copolymer.

16. The floor covering of claim 11 wherein said stain resist component is selected from the group consisting of: fluorochemical agents, acid-containing acrylic polymers, copolymers, ethoxylated polyesters, ethoxylated nylon, cellulose derivatives, polyacrylamides, sulfonated polymers, and sulfonated polyesters.

17. The floor covering of claim 11 wherein said floor covering is selected from the group consisting of: bonded carpet, woven carpet, nonwoven carpet, rugs, carpet mats, noncushioned carpets and carpet tiles.

18. A method for imparting soil resistance, stain resistance, and stain release properties to a floor covering textile comprising the steps of
providing a textile, said textile being comprised in part of fibers,
scouring said textile,
applying a chemical finish to said textile, said chemical finish being comprised of:
(a) a repellent component;
(b) a stain blocking component, wherein said stain blocking component provides stain resistance as well stain release characteristics to said textile; and
(c) a particulate component.

19. The method of claim 18 wherein said scoured floor covering textile comprises a carpet having a pile comprised of fibers, further wherein the percentage of oil residue in said scoured carpet fibers is less than about 0.3 percent by weight.

20. A process for making a floor covering article of manufacture, said process comprising the steps of:
providing a fibrous substrate, said fibrous substrate being comprised in part of tufted textile fibers or filaments;
contacting said fibrous substrate with an aqueous treatment composition comprising:
(a) a fluorochemical repellent component, said fluorochemical component being provided in a concentration of at least about 0.1% SOC;
(b) a stain resist component, said stain resist component being selected from at least one of the group consisting of: sulfonates, sulfonated novolak resins, and acrylic polymers; and
(c) a stain release component, said stain release component being selected from the group consisting of: fluorochemical agents, acid-containing acrylic polymers and copolymers, ethoxylated polyesters, ethoxylated nylon, cellulose derivatives, polyacrylamides, sulfonated polymers, and sulfonated polyesters; and
(d) a particulate component, said particulate component being selected from the group consisting of: silica-containing materials, zirconium-containing materials, titanium-containing materials, alumina-containing materials, inorganic oxides, basic metal salts, and metal oxides.

21. A carpet tile suitable for disposition as discrete modular units across a flooring surface, said carpet tile comprising:
(i) a primary carpet fabric having a pile side and an underside with a plurality of pile forming yams projecting outwardly from said pile side, said the pile side having fibers, said fibers having applied thereon a composition capable of affording substantial stain release to said fibers, said composition comprising:
(a) a repellent component;
(b) a stain resist component; and
(c) a particulate component;
(ii) an adhesive layer consisting essentially of at least one adhesive extending away from the underside of said primary carpet fabric; and
(iii) a layer of stabilizing material in contacting relationship with said adhesive layer such that said layer of stabilizing material is held in place at a fixed position below said primary carpet fabric.

22. A treated fiber-containing floor covering, said floor covering having applied to said fibers a composition comprising:
(a) a fluorochemical repellent component, said fluorochemical repellent component being provided at a concentration of at least about 0.1% SOC;
(b) a component capable of providing to said fiber-containing floor covering a substantial stain resist;
(c) a component capable of providing to said fiber-containing floor covering a substantial stain release; and
(d) a particulate component, said particulate component selected from the group of materials consisting of silica-containing materials, zirconium-containing materials, titanium-containing materials, alumina-containing materials, inorganic oxides, basic metal salts, and metal oxides.

23. The floor covering of claim 22 further wherein said particulate composition comprises at least one silica-containing material.

24 The floor covering of claim 22 further wherein said composition comprises at least one species of zirconia-containing material.

25. The floor covering of claim 22 wherein said composition is applied upon said fibers of said floor covering, further wherein said floor covering comprises a pile-containing carpet, said carpet being selected from the group of carpet types consisting of: bonded, woven, nonwoven, area rugs, carpet mats, non-cushioned carpets, and carpet tiles.

26. The pile-containing carpet of claim 25 wherein said carpet is tufted.

27. The tufted carpet of claim 26 wherein said fibers of said tufted carpet are comprised of nylon 6.

28. The tufted carpet of claim 26 wherein said fibers of said tufted carpet are comprised of nylon 6,6.

29. The tufted carpet of claim 26 wherein said tufted carpet is a cut pile construction.

30. The tufted carpet of claim 26 wherein said tufted carpet is a loop pile construction.

31. The carpet of claim 25 wherein said carpet is scoured, said carpet having fibers with less than about 0.3% by weight oil residue.

32. The carpet of claim 25 wherein said fibers of said carpet comprise polyester fibers.

33. The carpet of claim 25 wherein said fibers of said carpet comprise Type 6 nylon fibers.

34. The carpet of claim 25 wherein said fibers of said carpet comprises fibers selected from at least one of the group of fibers consisting of: polyester fibers, polypropylene fibers, wool fibers, polylactic acid fibers, acrylic fibers, and nylon 66 fibers.

35. The carpet of claim 25 wherein said particulate component comprises a silica-containing material.

36. The carpet of claim 25 wherein said particulate component comprises a zirconia-containing material.

37. The carpet of claim 25 wherein said particulate component comprises a alumina-containing material.

38. The carpet of claim 25 wherein said particulate component provides a primary particle size of between about 1 nm and about 100 nm.

39. A composition for imparting soil resistance and stain release to a pile-containing carpet, said composition comprising:
(a) a fluoroalkyl acrylate copolymer repellent component;
(b) a novolac resin-containing component;
(c) at least one component capable of imparting substantial stain release to said carpet; and
(d) a particulate component.

40. The composition of claim 39 further comprising:
(e) a crosslinking compound.

41. The composition of claim 39 wherein said at least one component capable of imparting stain release comprises a fluorochemical-containing compound, wherein said fluorochemical-containing compound is provided at a concention level of at least about 0.1% SOC.

42. A composition for treating a carpet, said composition comprising:
(a) a fluorochemical repellent component, said fluorochemical repellent component being applied at a concentration of at least about 0.1% SOC;
(b) a stain blocking component adapted for providing stain release; and
(c) a particulate component, said particulate component selected from the group of materials consisting of silica-containing materials, zirconium-containing materials, titanium-containing materials, alumina-containing materials, inorganic oxides, basic metal salts, and metal oxides;
wherein said composition is adapted for imparting substantial dry soil resistance, stain resist and a substantial stain release to said carpet.

43. The composition of claim 42 further wherein said particulate composition comprises a silica-containing material.

44. The composition of claim 42 further wherein said particulate composition comprises zirconia-containing material.

45. A scoured fibrous textile substrate treated with the composition of claim 42.

46. A floor covering having applied thereon a treating composition, said composition consisting essentially of:
(a) a fluorochemical repellent component applied in a concentration of at least about 0.1 percent SOC;
(b) a stain resist component, said stain resist component being selected from the group consisting of: sulfonated novalak resins and acrylic polymers;
(c) a stain release component, said stain release component being selected from one or more of the group consisting of: fluorochemicals, acrylic polymers, copolymers, acrylic copolymers, ethoxylated polyesters, ethoxylated nylon, cellulose derivatives, polyacrylamides, sulfonated polymers, and sulfonated polyesters and blends thereof; and
(d) a particulate component.

47. A treated floor covering substrate, said floor covering substrate having applied thereon a treating composition, said composition comprising:
(a) a repellent component;
(b) a stain resist component, said stain resist component further being capable of providing stain release properties to said floor covering substrate; and
(c) a particulate component;
wherein said floor covering substrate provides a relative resistance to dry soiling that reflects a color shade change ΔΔE in absolute value upon soiling and vacuuming of about 30 or less.

48. The treated floor covering substrate of claim 47 wherein the ΔΔE value in absolute value is about 20 or less.

49. The treated floor covering substrate of claim 47 wherein the ΔΔE value in absolute value is about 10 or less.

50. A scoured carpet having applied thereon a composition for imparting soil resistance, stain resistance, and stain release to said scoured carpet, said composition comprising:
(a) a first fluorochemical repellent component;
(b) a second stainblocking component, said stainblocking component being selected from the group consisting of: sulfonated novalak resins, acrylic polymers, sulfonated polyester polymers, sulfonated surfactants, fluorochemical agents, acid-containing acrylic or acrylate polymers, copolymers, ethoxylated polyesters, ethoxylated nylon, cellulose derivatives, polyacrylamides, sulfonated polymers, and sulfonated polyesters, and/or mixtures thereof;
(c) an inorganic particulate component, said inorganic particulate component being selected from the group consisting of: silica-containing materials, zirconium-containing materials, titanium-containing materials, alumina-containing materials, inorganic oxide materials, basic metal salt materials, and metal oxide materials; and
(d) wherein said scoured carpet exhibits a relative resistance to dry soiling that reflects a color shade change delta delta E upon soiling and vacuuming in absolute value of about 10 or less.

51. A chemically treated fiber-containing scoured floor covering, said floor covering having applied thereon a composition for imparting soil resistance, stain resistance, and stain release to fibers upon the surface of the floor covering, said composition comprising:
(a) a first fluorochemical repellent component;
(b) a second component, said second component being selected from at least one item from the group consisting of: i) sulfonated novolak resins, and ii) acrylic resins, and iii) blends of sulfonated novalak resins and acrylic resins;
(c) an particulate component, said particulate component being selected from the group consisting of: silica-containing materials, zirconium-containing materials, titanium-containing materials, alumina-containing materials, inorganic oxide materials, basic metal salt materials, and metal oxide materials; and
(d) wherein said chemically treated fiber-containing carpeting exhibits a resistance to dry soiling, ΔΔE value, in absolute terms, of about 20 or less and further shows improvement as compared to untreated floor covering when tested by modified AATCC Test Method 123-2000.
